(19) United States
(12) Patent Application Publication
(10) Pub. No.: US 2025/0095612 A1
(43) Pub. Date: Mar. 20, 2025

(54) Brasswind Replacement Parts

(71) Applicant: Dedrick Demond Bray, Harvey, LA (US)

(72) Inventor: Dedrick Demond Bray, Harvey, LA (US)

(21) Appl. No.: 18/777,182

(22) Filed: Jul. 18, 2024

Related U.S. Application Data
(60) Provisional application No. 63/628,633, filed on Aug. 8, 2023.

(51) Int. Cl. G10D 9/04; G10D 7/10

(52) U.S. Cl. CPC G10D 9/04; G10D 7/10

(57) ABSTRACT

Brasswind Replacement Parts is designed to address the urgent repair needs of brass instruments, including trumpets, trombones, tubas, and French horns. This innovative solution provides musicians with a comprehensive emergency repair kit, ensuring they can continue performing without disruption. Parts that are commonly needed for quick fixes and temporary solutions for minor cracks or leaks that are common with brass instruments. Musicians can quickly address common issues, ensuring performances continue smoothly. Also it makes emergency repair solutions available to musicians in remote or underserved areas where professional repair services are scarce. This will be a significant advancement in the care and maintenance of brass instruments musicians, music educators, and institutions worldwide. By providing musicians with the tools they need to perform emergency repairs, we enhance the reliability of performances and the longevity of instruments for years.

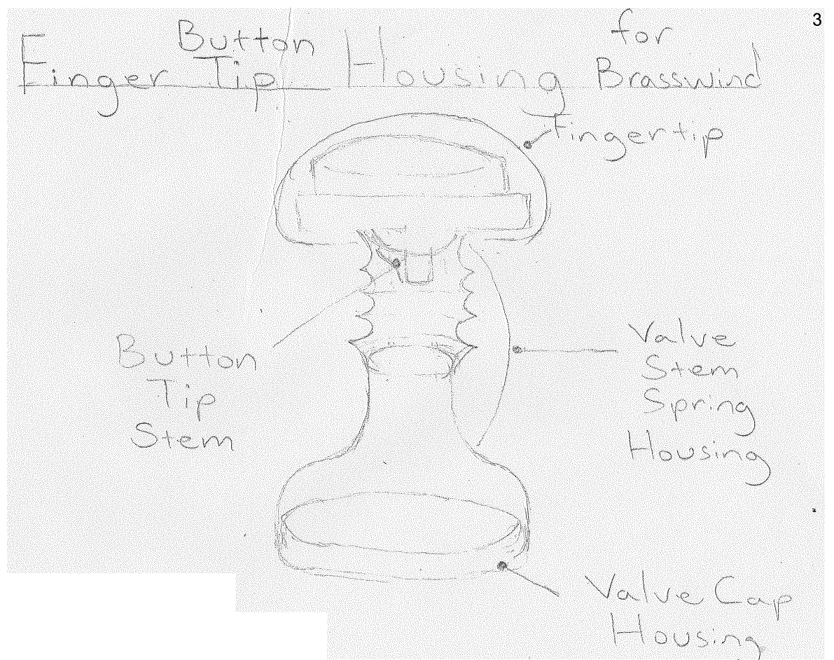

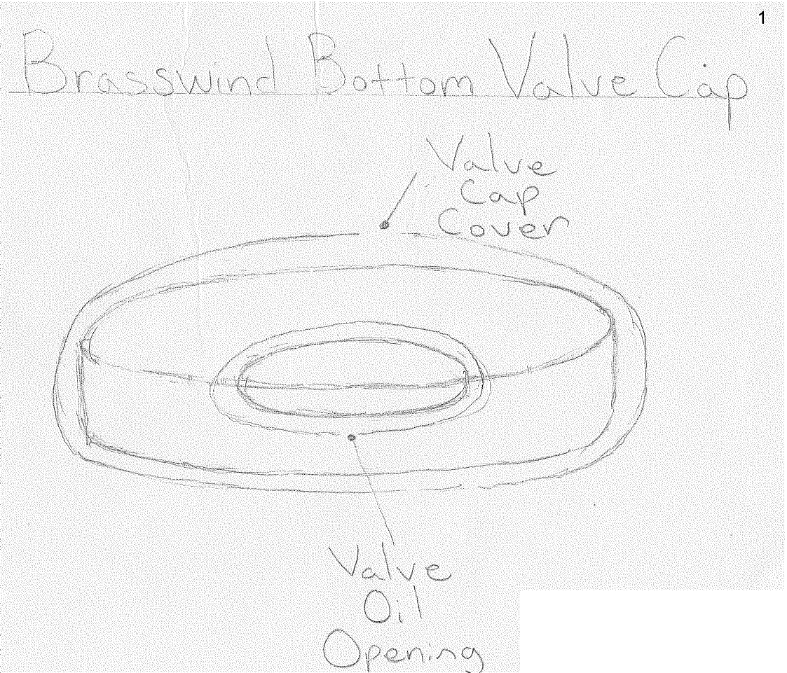

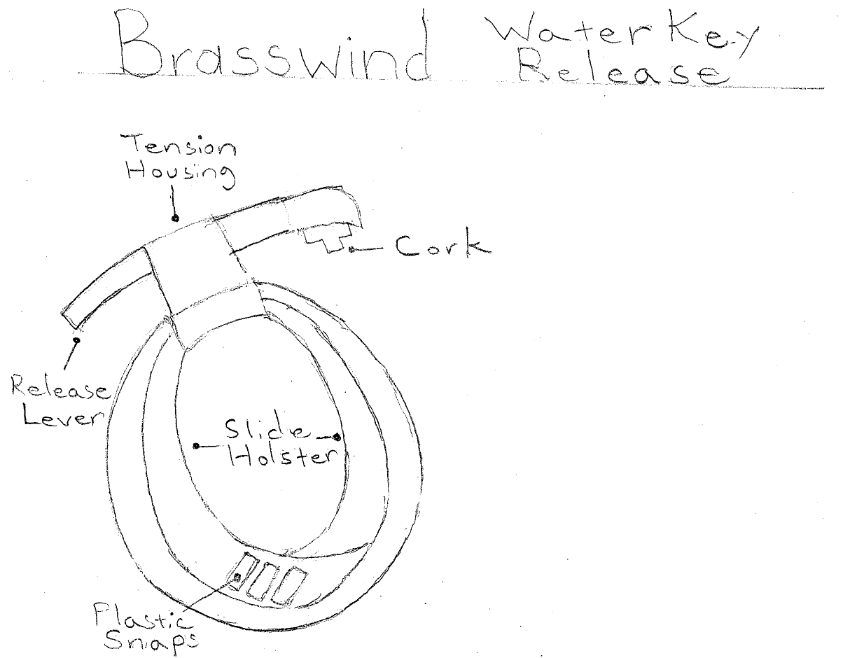

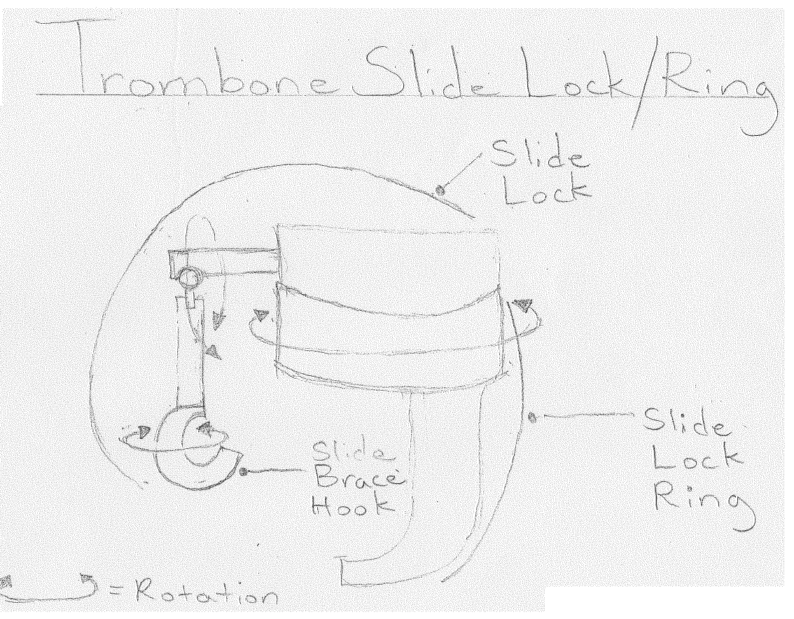

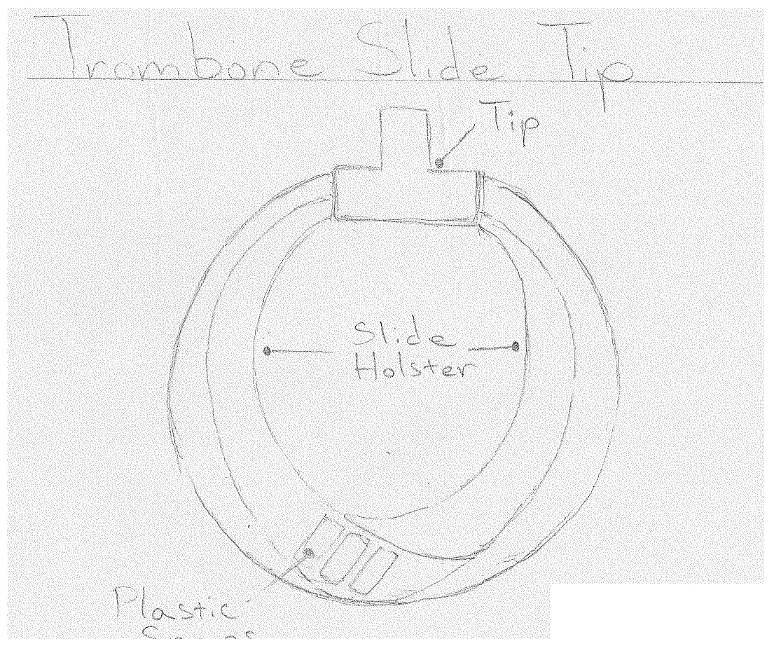

### BRASSWIND BOTTOM VALVE CAP

The brasswind bottom valve cap is a design to prevent damage to the threads on an instruments valve casing no matter if the bottom cap is missing or damage/beyond repair. The brasswind bottom valve cap is a one part device which consists two parts. The valve cap cover will be capped around the valve casing to protect the side and bottom threads. The valve oil opening is position to allow the player to insert valve oil instrument and to allow any excess oil/spit to escape from the valve casing. The valve cap cover is a part that can be used for temporary use on brass instruments such as trumpets, tubas/sousaphones, euphoniums/baritones, and marching mellophones/French horns.

### BRASSWIND WATER KEY RELEASE

The water key release is a design to replace water key release that broken from brasswind instruments and can't be soldered back on the instrument for different reasons. The water key release is a one piece device which consists of five parts. The tension housing will allow the release lever to stay in a down position until it's ready to be pressed down so the player can release the spit from the instrument water opening. The cork will be closed down tightly on the instrument water opening to prevent spit and air from escaping form the instrument. The slide holster will fit as a clamp around the tuning slide of the instrument and the snaps will prevent the device from moving out of position. The water key release is a part that can be used for temporary use on brass instruments such as trombones, trumpets, tubas/sousaphones, euphoniums/baritones, and marching mellophones/French horns.

### Finger Button Tip Housing For Brasswind Instruments

The finger button tip housing is a design to replace finger buttons tips that are misplace/broken for brasswind valve instruments. The finger button tip housing is a one piece device which consists of four parts. The finger button tip sits on top of the valve stem for comfort for the player/s fingertips while the valves are pressed up and down. The button tip stem sits inside the valve stem that is attached to the physical instrument and prevents the finger button tip from moving. The valve stem spring housing will be housed around the valve stem and will assist the finger button tip with the pressing of the valve. The valve cap housing will help the device stay attached to the instrument no matter if it's being or not. The finger button tip housing is a part that can be used for temporary use on brass instruments such as trumpets, tubas/sousaphones, euphoniums/baritones, and marching mellophones/French horns.

### Trombone Slide Lock/Ring

The trombone slide lock/ring is a design to replace broken/misplace trombone slide ring/lock and trombones that are not repairable. The trombone slide lock/ring is a one piece device which consists of three parts. The slide lock will be clamp around the slide receiver and attached to it will the slide brace hook which will be able to be attached/detached from the slide lock. The slide brace hook will be able to rotate 180 degrees allowing the player to hook the outer slide on the 1^{st} slide brace when ready to play and hook it on the 2^{nd} slide brace to lock the outer slide in place to protect the outer slide from being damage. The slide lock ring will be clamp around the slide receiver and will be able to rotate back and forth to lock and unlock the outer slide lock. The slide lock/ring is a part that can be used for temporary use on trombones.

### Trombone Slide Tip

The trombone slide tip is a design to help prevent damage or reoccurring damage to the trombone slide curve from concrete or floor type surfaces. The trombone slide tip is a one piece device which consists of three parts. The tip will fit over the metal tip that's attached the trombone and whenever the player holds the instrument in a downward position the tip will help the slide curve sit slightly off flat surfaces to prevent dents to the slide curve. The slide holster will clamp around the slide curve to prevent the device from moving around and the snaps will give the extra tension to ensure it's secured from moving out of position. The trombone slide tip is a part that can be used for temporary use on any trombone instrument.

1. An apparatus for replacing a broken trombone slide lock or a slide lock ring, wherein the trombone slide lock/ring has the following characteristics comprising of a slide lock, slide lock ring, and a slide brace hook made of silicone and polypropylene (PP).
A slide lock will freely be able to attach or detach to the slide receiver with the inner locking snaps for a securely bond to the instrument.
A slide lock ring which is attached to the slide lock will be able rotate 90 degrees, the slide lock ring 90 degree rotation will perform the duties of locking/unlocking the trombones outer slide lock.
A slide brace hook attachment can rotate 180 degrees left to right or up/down, a trombone outer slide can freely move when the slide brace hook is hooked to the trombone 1^{st} brace bar, when the slide brace hook is hooked to the trombone 2^{nd} brace bar it'll be looked in place, the slide brace hook can removed or added on to the slide lock.
